(19) United States
(12) Patent Application Publication
(10) Pub. No.: US 2026/0333021 A1
(43) Pub. Date: Oct. 22, 2026

(54) METHOD AND APPARATUS FOR TRANSMITTING CAPABILITY INFORMATION, AND READABLE STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/104,408

(22) PCT Filed: Aug. 18, 2022
(86) PCT No.: PCT/CN2022/113321

§ 371 Date: Feb. 18, 2025

(51) Int. Cl. H04W 8/24; H04L 1/00; H04W 72/51

(52) U.S. Cl. CPC H04W 8/24; H04L 1/0003; H04L 1/0009; H04W 72/51

(57) ABSTRACT

The present disclosure provides a method and apparatus for transmitting capability information, and a readable storage medium. The method comprises: receiving capability information sent by a user equipment, the capability information being used for indicating an error vector magnitude (EVM) capability of the user equipment, and scheduling the user equipment on the basis of the capability information. In the method of the present disclosure, a network device acquires the EVM capability of the user equipment according to the capability information reported by the user equipment, such that adaptive scheduling can be carried out on the basis of the EVM capability of the user equipment, the scheduling rationality can thus be improved, and the capability of the user equipment can also be fully utilized.

### TECHNICAL FILED

The present disclosure relates to the technical field of wireless communications, and in particular, to a method and device for transmitting capability information, and a readable storage medium.

### BACKGROUND

In wireless communication systems such as the Long Term Evolution (LTE) system or the 5G New Radio (NR) system, the quality of the transmitted signal from the User Equipment (UE) transmitter directly impacts the system's anti-interference ability and throughput. Hence, the quality of the UE's transmitted signal is a crucial transmitter indicator.

Error Vector Magnitude (EVM) is commonly employed to evaluate the quality of the UE's transmitted signal. The 3rd Generation Partnership Project (3GPP) protocol defines the minimum requirements for the UE's EVM. The EVM supported by the UE is related to its own radio frequency capabilities. Therefore, it is necessary to consider the influence of the UE's capabilities on scheduling.

### SUMMARY

This disclosure provides a method and device for transmitting capability information, and a readable storage medium.

According to a first aspect, this disclosure provides a method for receiving capability information, performed by a network device. The method includes: receiving capability information sent by user equipment, wherein the capability information is configured to indicate EVM capability of the user equipment; and scheduling the user equipment based on the capability information.

In this method, the network device can learn about the EVM capability of the user equipment from the capability information reported by the user equipment. Thus, the network device can perform adaptive scheduling according to the user equipment's EVM capability. This not only enhances the rationality of scheduling but also makes full use of the user equipment's capability.

In some possible implementations, the capability information is configured to indicate the EVM capability corresponding to all of frequency bands supported by the user equipment; or the capability information is configured to indicate the EVM capability of the user equipment corresponding to a specified frequency band.

In some possible implementations, the EVM capability of the user equipment is whether the user equipment has high EVM capability.

In some possible implementations, the high EVM capability is configured to indicate that, among a plurality of Modulation and Coding Schemes (MCSs) supported by the user equipment, an EVM supported by the user equipment under at least one MCS is lower than a preset value corresponding to the at least one MCS.

In some possible implementations, the capability information includes a bit configured to indicate whether the user equipment has the high EVM capability.

In some possible implementations, scheduling the user equipment based on the capability information includes: allocating, in a system bandwidth corresponding to the network device, a resource block close to a guard interval in the system bandwidth, to the user equipment having the high EVM capability according to the capability information.

In some possible implementations, scheduling the user equipment based on the capability information includes: configuring, according to the capability information, a MCS with a MCS index greater than a set value, for the user equipment having the high EVM capability.

In some possible implementations, scheduling the user equipment based on the capability information includes: configuring, in response to the capability information indicating that the user equipment supports the high EVM capability in a specified frequency band and the specified frequency band being a component carrier in Carrier Aggregation (CA), a priority of the carrier in the specified frequency band as a primary carrier to be higher than a priority of a carrier in a non-specified frequency band as the primary carrier.

According to a second aspect, this disclosure provides a method for sending capability information, performed by user equipment. The method includes: sending capability information to a network device, wherein the capability information is configured to indicate EVM capability of the user equipment.

In this method, the user equipment reports its own capability information to the network device. As a result, the network device can learn about the user equipment's EVM capability, facilitating the network device to perform adaptive scheduling based on the user equipment's EVM capability.

In some possible implementations, the capability information is configured to indicate the EVM capability corresponding to all of frequency bands supported by the user equipment; or the capability information is configured to indicate the EVM capability of the user equipment corresponding to a specified frequency band.

In some possible implementations, the EVM capability of the user equipment is whether the user equipment has high EVM capability.

In some possible implementations, the high EVM capability is configured to indicate that, among a plurality of MCSs supported by the user equipment, an EVM supported by the user equipment under at least one MCS is lower than a preset value corresponding to the at least one MCS.

In some possible implementations, the method further includes: in response to the user equipment having high EVM capability, performing, according to a configuration of the network device, data transmission on a resource block close to a guard interval in a system bandwidth corresponding to the network device.

In some possible implementations, the method further includes: in response to the user equipment having high EVM capability, performing, according to a configuration of the network device, uplink transmission using a MCS with a MCS index greater than a set value.

According to a third aspect, this disclosure provides a device for receiving capability information, which can be used to execute the steps performed by the network device in the first aspect or any possible design of the first aspect. The network device can implement each function in the above methods in the form of a hardware structure, a software module, or a combination of a hardware structure and a software module.

When the device in the third aspect is implemented by a software module, the device may include a transceiver module and a processing module that are coupled to each other. The transceiver module is used to support the communication device in communication, and the processing module is used to enable the communication device to perform processing operations, such as generating information/messages to be sent or processing received signals to obtain information/messages.

When executing the steps described in the first aspect, the transceiver module is configured to receive capability information sent by the user equipment. The capability information is used to indicate EVM capability of the user equipment.

The processing module is configured to schedule the user equipment based on the received capability information.

According to a fourth aspect, this disclosure provides a device for sending capability information, which can be used to execute the steps performed by the user equipment in the second aspect or any possible design of the second aspect. The user equipment can implement each function in the above methods in the form of a hardware structure, a software module, or a combination of a hardware structure and a software module.

When the device in the fourth aspect is implemented by a software module, the device may include a transceiver module, which is used to support the communication device in communication.

When executing the steps described in the second aspect, the transceiver module is configured to send capability information to the network device. The capability information is used to indicate EVM capability of the user equipment.

According to a fifth aspect, this disclosure provides a communication device, which includes a processor and a memory. The memory is used to store a computer program, and the processor is used to execute the computer program to implement the first aspect of any possible design in the first aspect.

According to a sixth aspect, this disclosure provides a communication device, which includes a processor and a memory. The memory is used to store a computer program, and the processor is used to execute the computer program to implement the second aspect or any possible design in the second aspect.

According to a seventh aspect, this disclosure provides a computer-readable storage medium in which instructions (or computer programs, programs) are stored. When these instructions are invoked and executed on a computer, the computer is caused to execute the first aspect or any possible design in the first aspect.

According to an eighth aspect, this disclosure provides a computer-readable storage medium in which instructions (or computer programs, programs) are stored. When these instructions are invoked and executed on a computer, the computer is caused to execute the second aspect or any possible design in the second aspect.

It should be understood that the above general description and the subsequent detailed description are merely exemplary and explanatory and do not limit this disclosure.

### BRIEF DESCRIPTION OF THE DRAWINGS

The accompanying drawings described herein are used to provide a further understanding of the embodiments of this disclosure and form a part of this application. The exemplary embodiments of this disclosure and their descriptions are used to explain this disclosure and do not constitute undue limitations on the embodiments of this disclosure. In the drawings:

The accompanying drawings are incorporated into the specification and form a part of the specification, showing some of embodiments consistent with this disclosure, and are used together with the specification to explain the principles of the embodiments of this disclosure.

FIG. 1 is a schematic diagram of the architecture of a wireless communication system provided according to embodiments of this disclosure.

FIG. 2 is a flowchart of a method for transmitting capability information according to an exemplary embodiment.

FIG. 3 is a flowchart of a method for receiving capability information according to an exemplary embodiment.

FIG. 4 is a flowchart of another method for receiving capability information according to an exemplary embodiment.

FIG. 5 is a schematic diagram of system bandwidth allocation according to an exemplary embodiment.

FIG. 6 is a flowchart of another method for receiving capability information according to an exemplary embodiment.

FIG. 7 is a flowchart of another method for receiving capability information according to an exemplary embodiment.

FIG. 8 is a flowchart of a method for sending capability information according to an exemplary embodiment.

FIG. 9 is a block diagram of a device for receiving capability information according to an exemplary embodiment.

FIG. 10 is a block diagram of a communication device according to an exemplary embodiment.

FIG. 11 is a block diagram of a device for sending capability information according to an exemplary embodiment.

FIG. 12 is a block diagram of user equipment according to an exemplary embodiment.

### DETAILED DESCRIPTION

The embodiments of this disclosure will now be further described in conjunction with the accompanying drawings and specific implementations.

Here, the exemplary embodiments will be described in detail, the examples of which are illustrated in the accompanying drawings. When the following description refers to the accompanying drawings, unless otherwise indicated, the same numbers in different drawings represent the same or similar elements. The implementations described in the following exemplary embodiments do not represent all implementations consistent with the embodiments of this disclosure. On the contrary, they are merely examples of devices and methods consistent with some aspects of this disclosure as detailed in the appended claims.

The terms used in the embodiments of this disclosure are solely for the purpose of describing specific embodiments and are not intended to limit the embodiments of this disclosure. The singular forms “a”, “an” and “the” used in the embodiments of this disclosure and the appended claims are also intended to include the plural forms, unless the context clearly indicates otherwise. It should also be understood that the term “and/or” used herein means and includes any or all possible combinations of one or more related listed items.

It should be understood that although terms such as “first,” “second,” and “third” may be used in the embodiments of this disclosure to describe various information, this information should not be limited by these terms. These terms are only used to distinguish information of the same type from one another. For example, without departing from the scope of the embodiments of this disclosure, the first information may also be referred to as the second information, and similarly, the second information may also be referred to as the first information. Depending on the context, the words “if” and “when” used herein can be interpreted as “at the time of . . . ”, “upon . . . ”, or “in response to determining”.

The embodiments of this disclosure will now be described in detail below. The examples of the embodiments are shown in the accompanying drawings, where the same or similar reference numerals represent the same or similar elements throughout. The embodiments described below with reference to the accompanying drawings are exemplary and are intended to explain this disclosure, and should not be construed as limiting this disclosure.

As shown in FIG. 1, a method for transmitting capability information provided by an embodiment of this disclosure can be applied to a wireless communication system 100. This wireless communication system may include user equipment 101 and a network device 102. The user equipment 101 is configured to support Carrier Aggregation (CA) and can be connected to multiple carrier units of the network device 102, including one primary carrier unit and one or more secondary carrier units.

It should be understood that the wireless communication system 100 described above is applicable to both low-frequency and high-frequency scenarios. The application scenarios of the wireless communication system 100 include, but are not limited to, a Long Term Evolution (LTE) system, an LTE Frequency Division Duplexing (FDD) system, an LTE Time Division Duplexing (TDD) system, a Worldwide Interoperability for Microwave Access (WiMAX) communication system, a Cloud Radio Access Network (CRAN) system, a future 5th-Generation (5G) system, a New Radio (NR) communication system, or a future evolved Public Land Mobile Network (PLMN) system, etc.

The user equipment 101 described above can be a terminal, an access terminal, a terminal unit, a terminal station, a Mobile Station (MS), a remote station, a remote terminal, a mobile terminal, a wireless communication device, a terminal agent, or a terminal device, etc. The user equipment 101 has a wireless transceiver function and can communicate (such as wirelessly) with one or more network devices of one or more communication systems and accept network services provided by the network devices. The network devices here include, but are not limited to, the illustrated network device 102.

The user equipment (UE) 101 can be a cellular phone, a cordless phone, a Session Initiation Protocol (SIP) phone, a Wireless Local Loop (WLL) station, a Personal Digital Assistant (PDA) device, a handheld device with a wireless communication function, a computing device, or other processing devices connected to a wireless modem, a vehicle-mounted device, a wearable device, a terminal device in a future 5G network, or a terminal device in a future evolved PLMN network, etc.

The network device 102 can be an access network device (or an access network site). The access network device refers to a device that provides a network access function, such as a Radio Access Network (RAN) base station, etc. The network device 102 can specifically include a base station (BS), or include a base station and a radio resource management device for controlling the base station, etc. The network device 102 can also include a relay station (relay device), an access point, and a base station in a future 5G network, a base station in a future evolved PLMN network, or an NR base station, etc. The network device 102 can be a wearable device or a vehicle-mounted device. The network device 102 can also be a communication chip with a communication module.

For example, the network device 102 includes, but is not limited to: a next-generation base station (gnodeB or gNB) in 5G, an evolved node B (eNB) in an LTE system, a Radio Network Controller (RNC), a node B (NB) in a WCDMA system, a radio controller under a CRAN system, a Base Station Controller (BSC), a Base Transceiver Station (BTS) in a GSM system or a CDMA system, a home base station (e.g., home evolved nodeB, or home node B (HNB)), a Baseband Unit (BBU), a Transmitting and Receiving Point (TRP), a Transmitting Point (TP), or a Mobile Switching Center, etc.

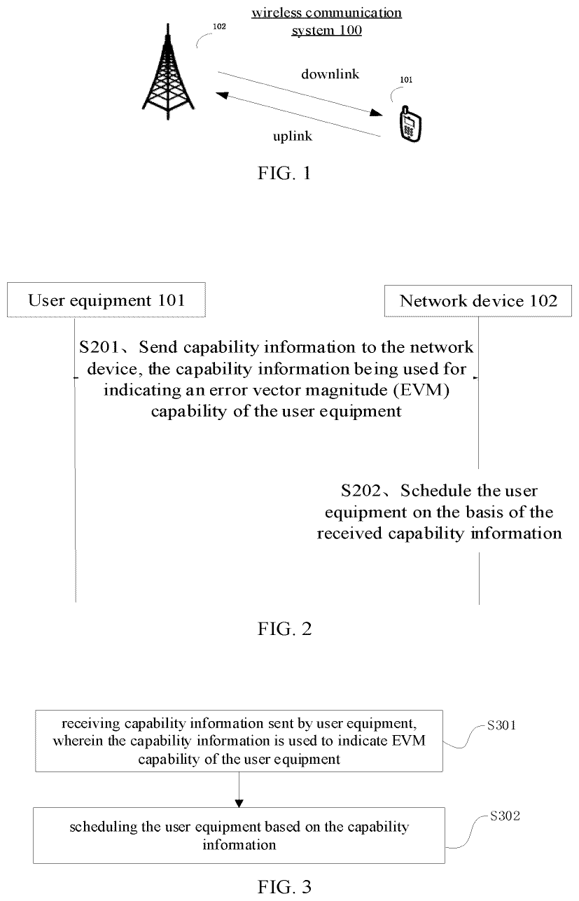

An embodiment of this disclosure provides a method for transmitting capability information. Referring to FIG. 2, FIG. 2 is a method for transmitting capability information according to an exemplary embodiment. As shown in FIG. 2, the method includes steps S201~S202, specifically:

Step S201, the user equipment 101 sends capability information to the network device 102. The capability information is used to indicate Error Vector Magnitude (EVM) capability of the user equipment.

Step S202, the network device 102 schedules the user equipment 101 according to the received capability information.

In some possible implementations, the EVM capability of the user equipment 101 is the same as that defined by the protocol.

Referring to Table 1, the protocol defines different minimum EVM requirements corresponding to different Modulation and Coding Schemes (MCSs). The larger the modulation order of the MCS, the smaller the required EVM value. Under the same modulation order, the smaller the EVM value, the better the quality of the transmitted signal of the UE.

TABLE 1

| MCS index | MCS | Unit | Average EVM Level |
|---|---|---|---|
| 0 | Pi/2-BPSK | % | 30 |
| 1 | QPSK | % | 17.5 |
| 2 | 16 QAM | % | 12.5 |
| 3 | 64 QAM | % | 8 |
| 4 | 256 QAM | % | 3.5 |

In some possible implementations, the EVM capability of the user equipment 101 is greater than the protocol requirements. That is, the EVM capability of the user equipment 101 is stronger, and it can support an EVM value smaller than the corresponding EVM in the protocol. Such user equipment 101 with strong capability has stronger anti-interference capability.

In some possible implementations, the capability information is reported on a user equipment 101 basis (i.e., per UE). That is, different UEs 101 report their corresponding capability information to the network device 102 respectively. The capability information reported by each user equipment 101 is applicable to all of the frequency bands (or simply referred as “bands”) supported by the UE.

In some possible implementations, the capability information is reported on a band basis (i.e., per band). That is, each user equipment 101 reports its capability information corresponding to at least one of frequency bands to the network device 102. The capability information reported by the user equipment 101 is applicable to a single frequency band that supports this capability, such as a specified frequency band.

In some possible implementations, when scheduling according to the capability information of the user equipment 101, the network device 102 can allocate the resource blocks close to a guard interval in a system bandwidth to the UE with strong capability. The UE with strong capability can still perform effective data transmission on these resource blocks. The network device 102 can allocate the resource blocks in the middle of the system bandwidth to the UE with weaker capability. The guard interval is an interval set at both ends of the bandwidth. To protect the signal quality within the band and suppress out-of-band radiation, the portion of the bandwidth occupied by the guard interval cannot be used for data transmission.

In some possible implementations, when scheduling according to the capability information of the user equipment 101, the network device 102 can configure a higher-order MCS for the UE with strong capability to improve the transmission quality.

In some possible implementations, when scheduling according to the capability information of the user equipment 101, the network device 102 can configure a higher priority for the UE with strong capability. For example, in Carrier Aggregation (CA), when the UE has strong EVM capability in a specified frequency band, the carrier in this specified frequency band can be configured to be prioritized as the primary carrier.

In the embodiments of this disclosure, the network device 102 learns the EVM capability of the user equipment 101 according to the capability information reported by the user equipment 101. Thus, the network device 102 can perform adaptive scheduling based on the EVM capability of the user equipment 101, which not only improves the rationality of scheduling but also makes full use of the capability of the user equipment 101. The effective scheduling of the user equipment 101 with strong capability can improve the throughput and anti-interference capabilities of the entire communication system.

An embodiment of this disclosure provides a method for transmitting capability information. This method includes steps S201′~S203′, specifically:

Step S201′, the user equipment 101 sends capability information to the network device 102. The capability information is used to indicate whether the user equipment 101 has high EVM capability.

Step S202′, according to the received capability information, the network device 102 allocates, in the system bandwidth corresponding to the network device 102, resource blocks close to a guard interval in the system bandwidth to the user equipment 101 having the high EVM capability.

Step S203′, in response to the user equipment 101 having the high EVM capability, the user equipment 101 performs data transmission on the resource blocks close to the guard interval in the system bandwidth corresponding to the network device 102, according to the configuration of the network device 102.

In some possible implementations, when the EVM supported by the user equipment 101 is lower than a preset value, the user equipment 101 is considered to have the high EVM capability.

In some possible implementations, the high EVM capability is used to indicate that, among a plurality of MCSs supported by the user equipment 101, the EVM supported by the user equipment 101 under at least one MCS is lower than a preset value corresponding to this MCS.

For example, when the user equipment 101 supports a plurality of MCSs and the EVM supported by the user equipment 101 under each MCS is lower than a preset value corresponding to this MCS, the user equipment 101 is considered to have the high EVM capability.

For another example, when the user equipment 101 supports a plurality of MCSs and the EVM supported by the user equipment 101 under any one MCS is lower than a preset value corresponding to this MCS, the user equipment 101 is considered to have the high EVM capability under this MCS.

In some possible implementations, referring to Table 1, the preset value corresponding to each MCS can be either an average EVM value defined by the protocol or a value lower than the average EVM value defined by the protocol.

In some possible implementations, the user equipment 101 with the high EVM capability has better transmitted signal quality, which can improve the anti-interference capability and throughput of the system. Referring to FIG. 5, resource blocks (RBs) close to the guard interval are allocated to the UE with strong capability. This UE can still perform effective data transmission using these resource blocks.

In some possible implementations, the network device 102 allocates n RBs on both ends of the system bandwidth and close to the guard interval to the user equipment 101 with the high EVM capability.

In some possible implementations, the value of n can be determined according to the actual scheduled traffic volume.

In the embodiments of this disclosure, the network device 102 performs adaptive scheduling in conjunction with the EVM capability of the user equipment 101 to fully utilize the anti-interference performance of the high EVM capability and reasonably allocate the transmission for the UE with low EVM capability, thereby improving the overall throughput of the system.

An embodiment of this disclosure provides a method for transmitting capability information. This method includes steps S201″~S203″, specifically:

Step S201″, the user equipment 101 sends capability information to the network device 102. The capability information is used to indicate whether the user equipment 101 has high EVM capability.

Step S202″, according to the capability information, the network device 102 configures a MCS with a MCS index greater than a set value for the user equipment 101 having the high EVM capability.

Step S203″, in response to the user equipment 101 having the high EVM capability, the user equipment 101 performs uplink transmission using the MCS with the MCS index greater than the set value according to the configuration of the network device 102.

In some possible implementations, when the EVM supported by the user equipment 101 is lower than a preset value, the user equipment 101 is considered to have the high EVM capability.

In some possible implementations, the high EVM capability is used to indicate that, among a plurality of MCSs supported by the user equipment 101, the EVM supported by the user equipment 101 under at least one MCS is lower than a preset value corresponding to this MCS.

For example, when the user equipment 101 supports a plurality of MCSs and the EVM supported by the user equipment 101 under each MCS is lower than a preset value corresponding to this MCS, the user equipment 101 is considered to have the high EVM capability.

For another example, when the user equipment 101 supports a plurality of MCSs and the EVM supported by the user equipment 101 under any one MCS is lower than a preset value corresponding to this MCS, the user equipment 101 is considered to have the high EVM capability under this MCS.

In some possible implementations, there is a correspondence relationship between the MCS index and the MCS, which can be seen from the illustration in Table 1. It should be understood that the MCS index values in Table 1 are merely indicative of their order and do not limit the specific MCS values corresponding to the MCSs.

In some possible implementations, the larger the MCS index, the larger the modulation order of the corresponding MCS. The larger the modulation order of the MCS, the smaller the EVM required by the UE.

In some possible implementations, the network device 102 can configure a higher modulation order for the UE with the high EVM capability in combination with the EVM capability of the UE.

In some possible implementations, the UE with the high EVM capability can perform uplink transmission using a higher-order MCS according to the MCS configured by the network device 102.

In the embodiments of the present disclosure, the network device 102, in conjunction with the capability information of the user equipment 101, fully utilizes the high anti-interference capability and high transmitted signal quality of the UE with high EVM capability for scheduling. This is beneficial for improving the overall system throughput and enhancing its resistance to various interferences.

An embodiment of this disclosure provides a method for receiving capability information, which is performed by the network device 102. Referring to FIG. 3, FIG. 3 is a method for receiving capability information according to an exemplary embodiment. As shown in FIG. 3, the method includes steps S301~S302, specifically:

Step S301, the network device 102 receives capability information sent by the user equipment 101. The capability information is used to indicate EVM capability of the user equipment 101.

Step S302, the network device 102 schedules the user equipment 101 based on the capability information.

In some possible implementations, the EVM capability of the user equipment 101 is the same as that defined by the protocol. The EVM defined by the protocol can be seen in Table 1.

In some possible implementations, the EVM capability of the user equipment 101 is greater than the protocol requirements. That is, the user equipment 101 has stronger EVM capability and can support an EVM value smaller than the corresponding EVM in the protocol.

In some possible implementations, the capability information of the user equipment 101 can reflect the signal quality of its transmitter. The network device 102 can perform adaptive scheduling according to the capability information of the user equipment 101.

In one example, when scheduling according to the capability information of the user equipment 101, the network device 102 can configure a higher-order MCS for the UE with strong capability to improve the transmission quality and configure a lower-order MCS for the UE with weaker capability.

In the embodiments of this disclosure, the network device 102 learns the EVM capability of the user equipment 101 according to the capability information reported by the user equipment 101. Thus, the network device 102 can perform adaptive scheduling based on the EVM capability of the user equipment 101, which not only improves the rationality of scheduling but also makes full use of the capability of the user equipment 101.

An embodiment of this disclosure provides a method for receiving capability information, which is performed by the network device 102. This method includes steps S301~S302, specifically:

Step S301, the network device 102 receives capability information sent by the user equipment 101. The capability information is used to indicate EVM capability of the user equipment 101.

Step S302, the network device 102 schedules the user equipment 101 based on the capability information.

The capability information is used to indicate the EVM capability corresponding to all of frequency bands supported by the user equipment. Alternatively, the capability information is used to indicate the EVM capability of the user equipment corresponding to a specified frequency band.

In some possible implementations, the capability information reported by the user equipment 101 is applicable to all the frequency bands (or simply referred as “bands”) supported by the UE. That is, the capability information can represent the EVM capability in any one of frequency bands supported by the user equipment 101.

In one example, different UEs 101 can report their respective capability information to the network device 102 on a per-UE basis.

In some possible implementations, the capability information reported by the user equipment 101 is applicable to a single frequency band that supports this capability. That is, the capability information can represent the EVM capability of user equipment 101 for the specified frequency band where this capability is supported.

In one example, each user equipment 101 can report the capability information corresponding to at least one of its frequency bands to the network device 102 on a per-band basis.

In the embodiments of this disclosure, the network device 102 can learn the EVM capability corresponding to the user equipment 101 or the EVM capability of the user equipment 101 in the specified frequency band according to the capability information reported by the user equipment 101.

An embodiment of this disclosure provides a method for receiving capability information, which is performed by the network device 102. This method includes steps S301′~S302, specifically:

Step S301′, the network device 102 receives capability information sent by the user equipment 101. The capability information is used to indicate whether the user equipment 101 has high EVM capability.

Step S302, the network device 102 schedules the user equipment 101 based on the capability information.

In some possible implementations, the user equipment 101 that has the high EVM capability can be the one whose supported EVM is smaller than a preset value when operating under the same modulation order.

In some possible implementations, the high EVM capability is used to indicate that, among a plurality of MCSs supported by the user equipment 101, the EVM supported by the user equipment 101 under at least one MCS is lower than a preset value corresponding to this MCS. That is, in this embodiment, each MCS is set with a corresponding preset value.

In one example, when the user equipment 101 supports a plurality of MCSs and the EVM supported by the user equipment 101 under each MCS is lower than a preset value corresponding to this MCS, the user equipment 101 is considered to have the high EVM capability.

In one example, when the user equipment 101 supports a plurality of MCSs and the EVM supported by the user equipment 101 under any one of the MCSs is lower than a preset value corresponding to this MCS, the user equipment 101 is considered to have the high EVM capability under this MCS.

In some possible implementations, the preset value corresponding to each MCS can be either an average EVM value defined by the protocol or a value lower than the average EVM value defined by the protocol.

For example, referring to Table 1, the preset value corresponding to QPSK can be set to 17.5% or a value smaller than 17.5%. The preset value corresponding to 16 QAM can be set to 12.5% or a value smaller than 12.5%. The preset value corresponding to 256 QAM can be set to 3.5% or a value smaller than 3.5%.

In one example, when the MCS is QPSK, the EVM defined by the protocol is 17.5%, and the preset value is set to, for example, 17.5%. When the EVM supported by the user equipment 101 under QPSK is smaller than 17.5%, it can be considered that the user equipment 101 has the high EVM capability.

In one example, when the MCS is QPSK, the preset value for QPSK is set to 12.25%. When the EVM supported by the user equipment 101 under QPSK is smaller than 12.5%, it can be considered that the user equipment 101 has the high EVM capability.

In some possible implementations, the preset value can be set related to the improvement ratio of the corresponding EVM defined by the protocol.

In one example, when the MCS is QPSK, the EVM defined by the protocol is 17.5%. When the improvement ratio of the EVM supported by the user equipment 101 under QPSK is not less than 30%, it is considered that the user equipment 101 has the high EVM capability. That is, when the EVM supported by the user equipment 101 under QPSK is smaller than 17.5%*(1−30%)=12.25%, it is considered that the user equipment 101 has the high EVM capability.

In some possible implementations, the capability information includes a bit used to indicate whether the user equipment 101 has the high EVM capability.

In some possible implementations, 1-bit information in the capability information is used to indicate whether the user equipment 101 has the high EVM capability.

In one example, when this 1-bit information is set to 1, it indicates that the user equipment 101 has the high EVM capability.

In one example, when this 1-bit information is set to 0, it indicates that the user equipment 101 does not have the high EVM capability.

In the embodiments of this disclosure, the network device 102 learns whether the user equipment 101 has the high EVM capability according to the capability information of the user equipment 101. Thus, the network device 102 can effectively schedule the user equipment 101 with the high EVM capability.

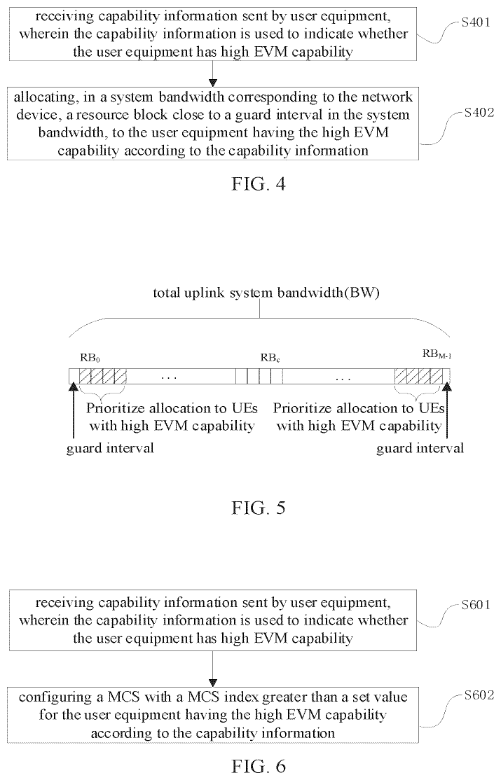

An embodiment of this disclosure provides a method for receiving capability information, which is performed by the network device 102. Referring to FIG. 4, FIG. 4 is a method for receiving capability information according to an exemplary embodiment. As shown in FIG. 4, the method includes steps S401~S402, specifically:

Step S401, the network device 102 receives capability information sent by the user equipment 101. The capability information is used to indicate whether the user equipment 101 has high EVM capability.

Step S402, according to the capability information, the network device 102 allocates, in a system bandwidth corresponding to the network device 102, resource blocks close to a guard interval in the system bandwidth to the user equipment 101 with the high EVM capability.

In some possible implementations, the user equipment 101 that has the high EVM capability can be the one whose supported EVM is smaller than a preset value when operating under the same modulation order.

In some possible implementations, the high EVM capability is used to indicate that, among a plurality of MCSs supported by the user equipment 101, the EVM supported by the user equipment 101 under at least one MCS is lower than a preset value corresponding to this MCS. That is, in this embodiment, each MCS is set with a corresponding preset value.

In one example, when the user equipment 101 supports a plurality of MCSs and the EVM supported by the user equipment 101 under each MCS is lower than a preset value corresponding to this MCS, the user equipment 101 is considered to have the high EVM capability.

In one example, when the user equipment 101 supports a plurality of MCSs and the EVM supported by the user equipment 101 under any one of the MCSs is lower than a preset value corresponding to this MCS, the user equipment 101 is considered to have the high EVM capability under this MCS.

In some possible implementations, referring to Table 1, the preset value corresponding to each MCS can be either an average EVM value defined by the protocol or a value lower than the average EVM value defined by the protocol.

In some possible implementations, the user equipment 101 with the high EVM capability has better transmitted signal quality, which can improve the anti-interference capability and throughput of the system. The RBs close to the guard interval are allocated to the UE with strong capability. This UE can still perform effective data transmission using these resource blocks.

In some possible implementations, the network device 102 allocates n RBs on both ends of the system bandwidth and close to the guard interval to the user equipment 101 with the high EVM capability.

In some possible implementations, the value of n can be determined according to the actual scheduled traffic volume.

In one example, when multiple UEs are located at the cell edge or experience poor channel quality, the network device 102 can allocate the system bandwidth (such as 20 MHz) according to the EVM capabilities of different UEs when scheduling resources. For example, referring to FIG. 5, the network device prioritizes allocating the n RBs close to the guard interval in the system bandwidth to the UEs with high EVM capabilities, and the RBs in the middle portion of the system bandwidth are allocated to other UEs.

In the embodiments of this disclosure, the network device 102 performs adaptive scheduling in combination with the EVM capability of the user equipment 101 to fully utilize the anti-interference performance of the high EVM capability and reasonably allocate the transmission for the UE with low EVM capability, thereby improving the overall throughput of the system.

An embodiment of this disclosure provides a method for receiving capability information, which is performed by the network device 102. Referring to FIG. 6, FIG. 6 is a method for receiving capability information according to an exemplary embodiment. As shown in FIG. 6, the method includes steps S601~S602, specifically:

Step S601, the network device 102 receives capability information sent by the user equipment 101. The capability information is used to indicate whether the user equipment 101 has high EVM capability.

Step S602, according to the capability information, the network device 102 configures a MCS with a MCS index greater than a set value for the user equipment 101 having the high EVM capability.

In some possible implementations, the user equipment 101 that has the high EVM capability can be the one whose supported EVM is smaller than a preset value when operating under the same modulation order.

In some possible implementations, the high EVM capability is used to indicate that, among a plurality of MCSs supported by the user equipment 101, the EVM supported by the user equipment 101 under at least one MCS is lower than a preset value corresponding to this MCS. That is, in this embodiment, each MCS is set with a corresponding preset value.

In one example, when the user equipment 101 supports a plurality of MCSs and the EVM supported by the user equipment 101 under each MCS is lower than a preset value corresponding to this MCS, the user equipment 101 is considered to have the high EVM capability.

In one example, when the user equipment 101 supports a plurality of MCSs and the EVM supported by the user equipment 101 under any one of the MCSs is lower than a preset value corresponding to this MCS, the user equipment 101 is considered to have the high EVM capability under this MCS.

In some possible implementations, the preset value corresponding to each MCS can be either an average EVM value defined by the protocol or a value lower than the average EVM value defined by the protocol.

In some possible implementations, there is a correspondence relationship between the MCS index and the MCS, which can be seen from the illustration in Table 1. It should be understood that the MCS index values in Table 1 are merely indicative of their order and do not limit the specific MCS values corresponding to the MCSs.

In some possible implementations, the larger the MCS index, the larger the modulation order of the corresponding MCS. The larger the modulation order of the MCS, the smaller the EVM required by the UE.

In some possible implementations, the network device 102 can configure a higher modulation order for the UE with the high EVM capability in combination with the EVM capability of the UE.

In some possible implementations, the UE with the high EVM capability can perform uplink transmission using a higher-order MCS according to the MCS configured by the network device 102.

In the embodiments of the present disclosure, the network device 102, in conjunction with the capability information of the user equipment 101, fully utilizes the high anti-interference capability and high transmitted signal quality of the UE with high EVM capabilities for scheduling. This is beneficial for improving the overall system throughput and enhancing its resistance to various interferences.

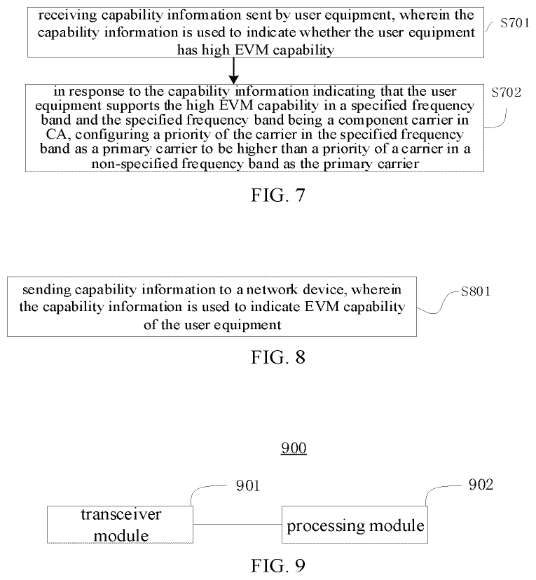

An embodiment of this disclosure provides a method for receiving capability information, which is performed by the network device 102. Referring to FIG. 7, FIG. 7 is a method for receiving capability information according to an exemplary embodiment. As shown in FIG. 7, the method includes steps S701~S702, specifically:

Step S701, the network device 102 receives capability information sent by the user equipment 101. The capability information is used to indicate whether the user equipment 101 has high EVM capability.

Step S702, in response to the capability information indicating that the user equipment 101 supports the high EVM capability in a specified frequency band and a carrier in the specified frequency band being a component carrier in CA, configuring a priority of the carrier in the specified frequency band as a primary carrier to be higher than a priority of a carrier in a non-specified frequency band as the primary carrier.

In some possible implementations, the user equipment 101 that has the high EVM capability can be the one whose supported EVM is smaller than a preset value when operating under the same modulation order.

In some possible implementations, the high EVM capability is used to indicate that, among a plurality of MCSs supported by the user equipment 101, the EVM supported by the user equipment 101 under at least one MCS is lower than a preset value corresponding to this MCS. That is, in this embodiment, each MCS is set with a corresponding preset value.

In one example, when the user equipment 101 supports a plurality of MCSs and the EVM supported by the user equipment 101 under each MCS is lower than a preset value corresponding to this MCS, the user equipment 101 is considered to have the high EVM capability.

In one example, when the user equipment 101 supports a plurality of MCSs and the EVM supported by the user equipment 101 under any one of the MCSs is lower than a preset value corresponding to this MCS, the user equipment 101 is considered to have the high EVM capability under this MCS.

In some possible implementations, the preset value corresponding to each MCS can be either an average EVM value defined by the protocol or a value lower than the average EVM value defined by the protocol.

In some possible implementations, this embodiment is applicable to the scenario where the UE reports EVM per band.

In some possible implementations, in the CA scenario, if a component carrier (i.e., Component Carrier, CC) in CA is in the specified frequency band, the CC can be configured to have a high priority as the primary carrier, and this CC is preferably selected as the primary carrier of CA.

In the embodiments of this disclosure, when scheduling in the CA scenario, the network device 102 can configure, in combination with the capability information of the user equipment 101, a high priority to a carrier in the specified frequency band that supports high EVM capability as the primary carrier.

An embodiment of this disclosure provides a method for sending capability information, which is performed by the user equipment 101. Referring to FIG. 8, FIG. 8 is a method for sending capability information according to an exemplary embodiment. As shown in FIG. 8, the method includes step S801, specifically:

Step S801, the user equipment 101 sends capability information to the network device 102. The capability information is used to indicate EVM capability of the user equipment 101.

In the embodiments of this disclosure, the user equipment 101 reports its own capability information to the network device 102, so that the network device 102 can learn the EVM capability of the user equipment 101, facilitating the network device 102 to perform adaptive scheduling based on the EVM capability of the user equipment 101.

An embodiment of this disclosure provides a method for sending capability information, which is performed by the user equipment 101. This method includes step S801, specifically:

Step S801, the user equipment 101 sends capability information to the network device 102. The capability information is used to indicate EVM capability of the user equipment 101.

The capability information is used to indicate the EVM capability corresponding to all of frequency bands supported by the user equipment. Alternatively, the capability information is used to indicate the EVM capability of the user equipment corresponding to a specified frequency band.

In some possible implementations, the EVM capability of the user equipment refers to whether it has high EVM capability.

In some possible implementations, the capability information includes a bit used to indicate whether the user equipment 101 has the high EVM capability.

In some possible implementations, 1-bit information in the capability information is used to indicate whether the user equipment 101 has the high EVM capability.

In some possible implementations, the high EVM capability is used to indicate that, among a plurality of MCSs supported by the user equipment 101, the EVM supported by the user equipment 101 under at least one MCS is lower than a preset value corresponding to this MCS.

In one example, when the user equipment 101 supports a plurality of MCSs and the EVM supported by the user equipment 101 under each MCS is lower than a preset value corresponding to this MCS, the user equipment 101 reports to the network device 102 that it has the high EVM capability.

In one example, when the user equipment 101 supports a plurality of MCSs and the EVM supported by the user equipment 101 under any one MCS is lower than a preset value corresponding to this MCS, the user equipment 101 reports to the network device 102 that it has the high EVM capability under this MCS.

In some possible implementations, referring to Table 1, the preset value corresponding to each MCS can be either an average EVM value defined by the protocol or a value lower than the average EVM value defined by the protocol.

An embodiment of this disclosure provides a method for sending capability information, which is performed by the user equipment 101. This method includes steps S801~S802, specifically:

Step S801, the user equipment 101 sends capability information to the network device 102. The capability information is used to indicate EVM capability of the user equipment 101.

Step S802, in response to the user equipment 101 having the high EVM capability, the user equipment 101 performs data transmission on resource blocks close to a guard interval in a system bandwidth corresponding to the network device 102 according to a configuration of the network device 102.

In some possible implementations, according to the capability information, the network device 102 allocates, in the system bandwidth corresponding to the network device 102, the resource blocks close to the guard interval in the system bandwidth to the user equipment 101 having the high EVM capability.

In the embodiments of this disclosure, the network device 102 performs adaptive scheduling in combination with the EVM capability of the user equipment 101 to fully utilize the anti-interference performance of the high EVM capability and reasonably allocate the transmission for the UE with low EVM capability, thereby improving the overall throughput of the system.

An embodiment of this disclosure provides a method for sending capability information, which is performed by the user equipment 101. This method includes steps S801~S802′, specifically:

Step S801, the user equipment 101 sends capability information to the network device 102. The capability information is used to indicate EVM capability of the user equipment 101.

Step S802′, in response to the user equipment 101 having high EVM capability, the user equipment 101 performs uplink transmission using a MCS with a MCS index greater than a set value according to the configuration of the network device 102.

In some possible implementations, according to the capability information, the network device 102 configures a MCS with a MCS index greater than a set value for the user equipment 101 having the high EVM capability.

In some possible implementations, there is a correspondence relationship between the MCS index and the MCS, which can be seen from the illustration in Table 1.

In some possible implementations, the larger the MCS index, the larger the modulation order of the corresponding MCS. The larger the modulation order of the MCS, the smaller the EVM required by the UE.

In the embodiments of this disclosure, the network device 102, in conjunction with the capability information of the user equipment 101, fully utilizes the high anti-interference capability and high transmitted signal quality of the UE with high EVM capability for scheduling. This is beneficial for improving the overall system throughput and enhancing its resistance to various interferences.

Based on the same concept as the above method embodiments, the embodiments of this disclosure also provide a device for receiving capability information. This device can have the functions of the network device 102 in the above method embodiments and can be used to execute the steps executed by the network device 102 provided in the above method embodiments. This function can be implemented by hardware, software, or hardware executing corresponding software. The hardware or software includes one or more modules corresponding to the above functions.

In a possible implementation, the communication device 900 shown in FIG. 9 can be used as the network device 102 involved in the above method embodiments and execute the steps executed by the network device 102 in the above method embodiments. As shown in FIG. 9, the communication device 900 may include a transceiver module 901 and a processing module 902 that are coupled to each other. The transceiver module 901 can be used to support the communication device in communication. The transceiver module 901 can have a wireless communication function, for example, it can perform wireless communication with other communication devices through the wireless air interface. The processing module 902 can be used to enable the communication device to perform processing operations, such as generating information/messages to be sent or processing received signals to obtain information/messages.

When executing the steps implemented by the network device 102, the transceiver module 901 is configured to receive capability information sent by the user equipment. The capability information is used to indicate EVM capability of the user equipment.

The processing module 902 is configured to schedule the user equipment based on the capability information.

In some possible implementations, the capability information is configured to indicate the EVM capability corresponding to all of frequency bands supported by the user equipment; or the capability information is configured to indicate the EVM capability of the user equipment corresponding to a specified frequency band.

In some possible implementations, the EVM capability of the user equipment is whether the user equipment has high EVM capability.

In some possible implementations, the high EVM capability is configured to indicate that, among a plurality of MCSs supported by the user equipment 101, an EVM supported by the user equipment 101 under at least one MCS is lower than a preset value corresponding to the at least one MCS.

In some possible implementations, the capability information includes a bit configured to indicate whether the user equipment has the high EVM capability.

In some possible implementations, the processing module 902 is further configured to allocate, in a system bandwidth corresponding to the network device, a resource block close to a guard interval in the system bandwidth, to the user equipment having the high EVM capability according to the capability information.

In some possible implementations, the processing module 902 is further configured to configure, according to the capability information, a MCS with a MCS index greater than a set value, for the user equipment having the high EVM capability.

In some possible implementations, the processing module 902 is further configured to configure, in response to the capability information indicating that the user equipment supports the high EVM capability in a specified frequency band and the specified frequency band being a component carrier in CA, a priority of the carrier in the specified frequency band as a primary carrier to be higher than a priority of a carrier in a non-specified frequency band as the primary carrier.

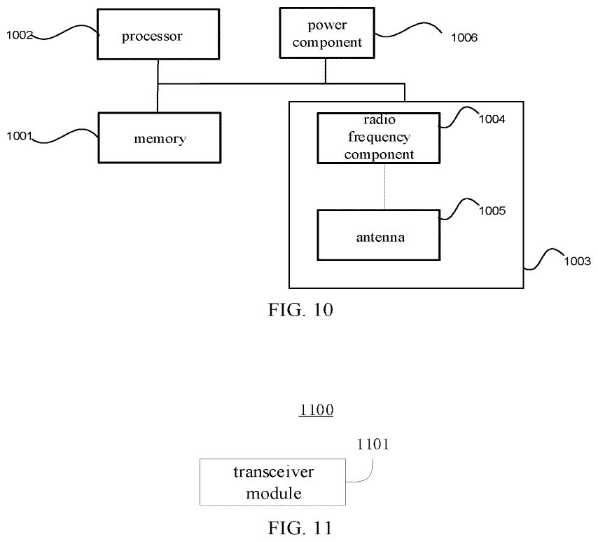

When this communication device is the network device 102, its structure can also be as shown in FIG. 10. Taking a base station as an example to illustrate the structure of the communication device. As shown in FIG. 10, the device 1000 includes a memory 1001, a processor 1002, a transceiver component 1003, and a power component 1006. The memory 1001 is coupled to the processor 1002 and can be used to store the programs and data necessary for the communication device 1000 to implement various functions. The processor 1002 is configured to support the communication device 1000 to execute the corresponding functions in the above method, and the functions can be realized by calling the programs stored in the memory 1001. The transceiver component 1003 can be a wireless transceiver, which is used to support the communication device 1000 to receive signaling and/or data through the wireless air interface, and send signaling and/or data. The transceiver component 1003 can also be referred to as a transceiver unit or a communication unit. The transceiver component 1003 can include a radio frequency component 1004 and one or more antennas 1005. The radio frequency component 1004 can be a Remote Radio Unit (RRU), which is specifically used for the transmission of radio frequency signals and the conversion between radio frequency signals and baseband signals. The one or more antennas 1005 are specifically used for the radiation and reception of radio frequency signals.

When the communication device 1000 needs to send data, the processor 1002 can perform baseband processing on the data to be sent and output the baseband signal to the radio frequency unit. The radio frequency unit performs radio frequency processing on the baseband signal and sends the radio frequency signal in the form of electromagnetic waves through the antenna. When data is sent to the communication device 1000, the radio frequency unit receives the radio frequency signal through the antenna, converts the radio frequency signal into a baseband signal, and outputs the baseband signal to the processor 1002. The processor 1002 converts the baseband signal into data and processes the data.

Based on the same concept as the above method embodiments, the embodiments of this disclosure also provide a device for sending capability information. This device can have the functions of the user equipment 101 in the above method embodiments and can be used to execute the steps executed by the user equipment 101 provided in the above method embodiments. This function can be implemented by hardware, software, or hardware executing corresponding software. The hardware or software includes one or more modules corresponding to the above functions.

In a possible implementation, the device 1100 shown in FIG. 11 can be used as the user equipment 101 involved in the above method embodiments and execute the steps executed by the user equipment 101 in the above method embodiments. As shown in FIG. 11, the device 1100 may include a transceiver module 1101, where the transceiver module 1101 can be used to support the communication device in communication.

When executing the steps implemented by the user equipment 101, the transceiver module 1101 is configured to send capability information to the network device. The capability information is used to indicate EVM capability of the user equipment.

In some possible implementations, the capability information is configured to indicate the EVM capability corresponding to all of frequency bands supported by the user equipment; or the capability information is configured to indicate the EVM capability of the user equipment corresponding to a specified frequency band.

In some possible implementations, the EVM capability of the user equipment is whether the user equipment has high EVM capability.

In some possible implementations, the high EVM capability is configured to indicate that, among a plurality of MCSs supported by the user equipment 101, an EVM supported by the user equipment 101 under at least one MCS is lower than a preset value corresponding to the at least one MCS.

In some possible implementations, the device 1100 further includes a processing module coupled to the transceiver module 1101. The processing module is configured to, in response to the user equipment having high EVM capability, performing, according to a configuration of the network device, data transmission on a resource block close to a guard interval in a system bandwidth corresponding to the network device.

In some possible implementations, the processing module is further configured to, in response to the user equipment having high EVM capability, performing, according to a configuration of the network device, uplink transmission using a MCS with a MCS index greater than a set value.

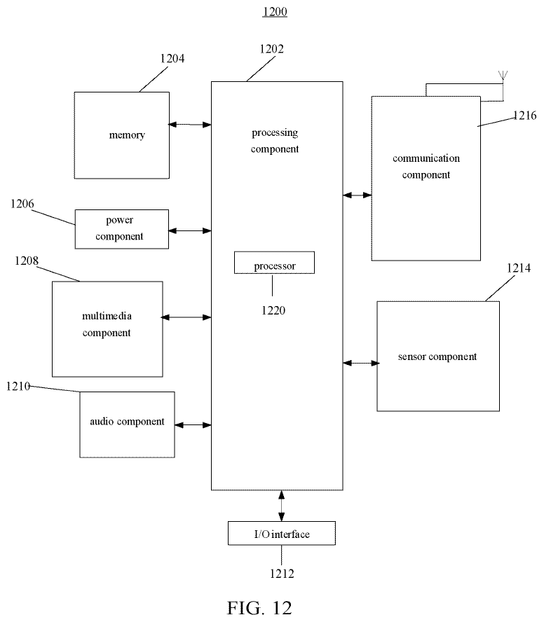

When this device for receiving configuration information is the user equipment 101, its structure can also be as shown in FIG. 12. The device 1200 can be a mobile phone, a computer, a digital broadcast terminal, a message sending and receiving device, a game console, a tablet device, a medical device, a fitness device, a personal digital assistant, etc.

Referring to FIG. 12, the device 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 usually controls the overall operation of the device 1200, such as operations related to display, phone calls, data communication, camera operations, and recording operations. The processing component 1202 can include one or more processors 1220 to execute instructions to complete all or part of the steps of the above methods. In addition, the processing component 1202 can include one or more modules to facilitate the interaction between the processing component 1202 and other components. For example, the processing component 1202 can include a multimedia module to facilitate the interaction between the multimedia component 1208 and the processing component 1202.

The memory 1204 is configured to store various types of data to support the operation of the device 1200. Examples of these data include instructions for any application or method operating on the device 1200, contact data, phone book data, messages, pictures, videos, etc. The memory 1204 can be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disc.

The power component 1206 provides power to various components of the device 1200. The power component 1206 can include a power management system, one or more power supplies, and other components related to generating, managing, and distributing power for the device 1200.

The multimedia component 1208 includes a screen that provides an output interface between the device 1200 and the user. In some embodiments, the screen can include a Liquid Crystal Display (LCD) and a Touch Panel (TP). If the screen includes a touch panel, the screen can be implemented as a touch screen to receive input signals from the user. The touch panel includes one or more touch sensors to sense touches, slides, and gestures on the touch panel. The touch sensors can not only sense the boundaries of touch or slide actions but also detect the duration and pressure associated with touch or slide operations. In some embodiments, the multimedia component 1208 includes a front camera and/or a rear camera. When the device 1200 is in an operating mode, such as a shooting mode or a video mode, the front camera and/or the rear camera can receive external multimedia data. Each front camera and rear camera can be a fixed optical lens system or have a focal length and optical zoom capabilities.

The audio component 1210 is configured to output and/or input audio signals. For example, the audio component 1210 includes a Microphone (MIC). When the device 1000 is in an operating mode, such as a call mode, a recording mode, and a voice recognition mode, the microphone is configured to receive external audio signals. The received audio signals can be further stored in the memory 1204 or sent via the communication component 1216. In some embodiments, the audio component 1210 also includes a speaker for outputting audio signals.

The I/O interface 1212 provides an interface between the processing component 1202 and peripheral interface modules. The peripheral interface modules can be a keyboard, a click wheel, buttons, etc. These buttons can include, but are not limited to: a home button, a volume button, a start button, and a lock button.

The sensor component 1214 includes one or more sensors for providing status assessments of various aspects of the device 1200. For example, the sensor component 1214 can detect the on/off state of the device 1200, the relative positioning of components. For example, when the components are the display and keypad of the device 1200, the sensor component 1214 can also detect the position change of the device 1200 or one of its components, the presence or absence of user contact with the device 1200, the orientation or acceleration/deceleration of the device 1200, and the temperature change of the device 1200. The sensor component 1214 can include a proximity sensor configured to detect the presence of nearby objects without any physical contact. The sensor component 1214 can also include a light sensor, such as a Complementary Metal-Oxide-Semiconductor (CMOS) or Charge-Coupled Device (CCD) image sensor, for use in imaging applications. In some embodiments, the sensor component 1214 can also include an acceleration sensor, a gyroscope sensor, a magnetic sensor, a pressure sensor, or a temperature sensor.

The communication component 1216 is configured to facilitate wired or wireless communication between the device 1200 and other devices. The device 1200 can access a wireless network based on communication standards, such as Wi-Fi, 2G, or 3G, or a combination thereof. In an exemplary embodiment, the communication component 1216 receives broadcast signals or broadcast-related information from an external broadcast management system via a broadcast channel. In an exemplary embodiment, the communication component 1216 also includes a Near Field Communication (NFC) module to facilitate short-range communication. For example, the NFC module can be implemented based on Radio Frequency Identification (RFID) technology, Infrared Data Association (IrDA) technology, Ultra Wideband (UWB) technology, Bluetooth® (BT) technology, and other technologies.

In an exemplary embodiment, the device 1200 can be implemented by one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to execute the above methods.

In an exemplary embodiment, a non-transitory computer-readable storage medium including instructions is also provided, such as the memory 1204 including instructions. The instructions can be executed by the processor 1220 of the device 1200 to complete the above methods. For example, the non-transitory computer-readable storage medium can be a ROM, a Random Access Memory (RAM), a Compact Disc Read-Only Memory (CD-ROM), magnetic tape, a floppy disk, and an optical data storage device, etc.

Those skilled in the art, after considering the specification and practicing the invention disclosed herein, will readily conceive of other embodiments of this disclosure. This disclosure is intended to cover any variations, uses, or adaptations of the embodiments of this disclosure. These variations, uses, or adaptations follow the general principles of the embodiments of this disclosure and include common knowledge or conventional technical means in the technical field of this disclosure that are not disclosed herein. The specification and embodiments are only considered exemplary, and the true scope and spirit of the embodiments of this disclosure are indicated by the following claims.

It should be understood that the embodiments of this disclosure are not limited to the precise structures described above and shown in the drawings, and various modifications and changes can be made without departing from its scope. The scope of the embodiments of this disclosure is only limited by the appended claims.

### INDUSTRIAL APPLICABILITY

In the embodiments of this disclosure, the network device learns the EVM capability of the user equipment according to the capability information reported by the user equipment. Thus, it can perform adaptive scheduling based on the EVM capability of the user equipment, which not only improves the rationality of scheduling but also makes full use of the capability of the user equipment. The effective scheduling of the user equipment with strong capability can improve the throughput and anti-interference capabilities of the entire communication system.

What is claimed is:

1. A method for receiving capability information, performed by a network device, the method comprising:
receiving capability information sent by user equipment, wherein the capability information is configured to indicate Error Vector Magnitude (EVM) capability of the user equipment; and
scheduling the user equipment based on the capability information.

2. The method according to claim 1, wherein the capability information is configured to indicate
the EVM capability corresponding to all of frequency bands supported by the user equipment; or
the EVM capability of the user equipment corresponding to a specified frequency band.

3. The method according to claim 1 or 2, wherein the EVM capability of the user equipment is whether the user equipment has high EVM capability.

4. The method according to claim 3, wherein the high EVM capability is configured to indicate that, among a plurality of Modulation and Coding Schemes (MCSs) supported by the user equipment, an EVM supported by the user equipment under at least one MCS is lower than a preset value corresponding to the at least one MCS.

5. The method according to claim 3, wherein the capability information comprises a bit configured to indicate whether the user equipment has the high EVM capability.

6. The method according to claim 3, wherein scheduling the user equipment based on the capability information comprises:
allocating, in a system bandwidth corresponding to the network device, a resource block close to a guard interval in the system bandwidth, to the user equipment having the high EVM capability according to the capability information.

7. The method according to claim 3, wherein scheduling the user equipment based on the capability information comprises:
configuring, according to the capability information, a Modulation and Coding Scheme (MCS) with a MCS index greater than a set value, for the user equipment having the high EVM capability.

8. The method according to claim 3, wherein scheduling the user equipment based on the capability information comprises:
configuring, in response to the capability information indicating that the user equipment supports the high EVM capability in a specified frequency band and the specified frequency band being a component carrier in Carrier Aggregation (CA), a priority of the carrier in the specified frequency band as a primary carrier to be higher than a priority of a carrier in a non-specified frequency band as the primary carrier.

9. A method for sending capability information, performed by user equipment, the method comprising:
sending capability information to a network device, wherein the capability information is configured to indicate Error Vector Magnitude (EVM) capability of the user equipment.

10. The method according to claim 9, wherein the capability information is configured to indicate
the EVM capability corresponding to all of frequency bands supported by the user equipment; or
the EVM capability of the user equipment corresponding to a specified frequency band.

11. The method according to claim 9 or 10, wherein the EVM capability of the user equipment is whether the user equipment has high EVM capability.

12. The method according to claim 11, wherein the high EVM capability is configured to indicate that, among a plurality of Modulation and Coding Schemes (MCSs) supported by the user equipment, an EVM supported by the user equipment under at least one MCS is lower than a preset value corresponding to the at least one MCS.

13. The method according to claim 9, further comprising:
in response to the user equipment having high EVM capability, performing, according to a configuration of the network device, data transmission on a resource block close to a guard interval in a system bandwidth corresponding to the network device.

14. The method according to claim 9, further comprising:
in response to the user equipment having high EVM capability, performing, according to a configuration of the network device, uplink transmission using a Modulation and Coding Scheme (MCS) with a MCS index greater than a set value.

15. A device for receiving capability information, configured in a network device, the device comprising:
a transceiver module configured to receive capability information sent by user equipment, wherein the capability information is configured to indicate Error Vector Magnitude (EVM) capability of the user equipment; and
a processing module configured to schedule the user equipment based on the capability information.

16. A device for sending capability information, configured in user equipment, the device comprising:
a transceiver module configured to send capability information to a network device, wherein the capability information is configured to indicate Error Vector Magnitude (EVM) capability of the user equipment.

17. A communication device, comprising:
a memory configured to store a computer program; and
a processor configured to execute the computer program to implement the method according to any one of claims 1-8.

18. A communication device, comprising:
a memory configured to store a computer program; and
a processor configured to execute the computer program to implement the method according to any one of claims 9-14.

19. A computer-readable storage medium storing instructions that, when invoked and executed on a computer, cause the computer to perform the method according to any one of claims 1-8.

20. A computer-readable storage medium storing instructions that, when invoked and executed on a computer, cause the computer to perform the method according to any one of claims 9-14.
